(19) United States
(12) Patent Application Publication
(10) Pub. No.: US 2017/0032321 A1
(43) Pub. Date: Feb. 2, 2017

(54) MULTIPLE MONITOR COMPUTING SYSTEM

(71) Applicant: Tremaine Jackson, W. Covina, CA (US)

(72) Inventor: Tremaine Jackson, W. Covina, CA (US)

(21) Appl. No.: 14/633,437

(22) Filed: Feb. 27, 2015

(51) Int. Cl. G06Q 10/10; G06Q 20/08; G06F 17/30

(52) U.S. Cl. CPC G06Q 10/1053; G06F 17/30867; G06Q 20/085

(57) ABSTRACT

A method of job recruiting between an employer network and a jobseeker network is a more efficient process to match various job seeking users to various potential employers. The process begins by retrieving employment qualifications from each of the job seeking user and by retrieving employment requirements from each of the potential employers. The process continues by comparing the employment qualifications of each job seeking user to the employment requirements for any of the potential employers in order to identify the pre-qualified candidates amongst the job seeking users. The process moves forward by send a notification of the pre-qualified candidates to the potential employers so that the potential employers are aware of the pre-qualified candidates. The process concludes by the sending an alert to the pre-qualified candidates about job opportunities from the potential employers.

The current application claims a priority to the U.S. Provisional Patent application Ser. No. 62/091,671 filed on Dec. 15, 2014.

### FIELD OF THE INVENTION

The present invention relates generally to a method for online recruiting. More specifically, the present invention is a web-based system and portal for recruiting for professional service industries.

### BACKGROUND OF THE INVENTION

Currently, there are many websites that provide a means for connecting recruiters and jobseekers such as Monster.com, and CareerBuilder. Companies use these sites to post open positions for hiring, and jobseekers use these sites to look for and apply to positions of interest. However, online job boards such as those mentioned above provide a very limited pre-qualification process. Thus, matching criteria such as job requirements and jobseeker qualifications can be difficult and cumbersome for employers to measure. It is therefore an object of the present invention to provide a web-based system and portal for recruiting which utilizes a unique process to match jobseekers to employers, as well as to match job descriptions to each jobseeker's specific background in a significantly more comprehensive manner than is presently available.

### BRIEF DESCRIPTION OF THE DRAWINGS

FIG. 1 is a diagram illustrating how the system of the present invention is interconnecting the employer network and the jobseeker network.

FIG. 2 is a flowchart describing the overall process followed by the method of the present invention.

FIG. 3 is a flowchart describing a process using job posting templates and job seeking criteria to improve the efficiency of the present invention.

FIG. 4 is a flowchart describing a process of selecting a job posting based on a plurality of job types to improve the efficiency of the present invention.

FIG. 5 is a flowchart describing a process of selecting essential duties for a job posting in order to improve the efficiency of the present invention.

FIG. 6 is a flowchart providing details of the comparison step in the overall process.

FIG. 7 is a flowchart describing an interview process being managed by the present invention.

FIG. 8 is a flowchart describing a process to generate a graphical summarization interface.

FIG. 9 is a flowchart describing a process to update a candidate profile after the job seeking user is hired by a potential employer.

FIG. 10 is a flowchart describing a process of maintaining a consistent price range for usage of the present invention.

### DETAILED DESCRIPTION OF THE INVENTION

All illustrations of the drawings are for the purpose of describing selected versions of the present invention and are not intended to limit the scope of the present invention.

The present invention is a method of job recruiting between an employer network and a jobseeker network. The present invention is preferably designed as an Internet- or web-based system and portal. The employer network allows users that are employers to communicate and to access the present invention. Similarly, the jobseeker network allows users that are looking for job opportunities to communicate and to access the present invention. The present invention allows users within the employer network to find a better match of users within the jobseeker network through a comprehensive pre-qualification process.

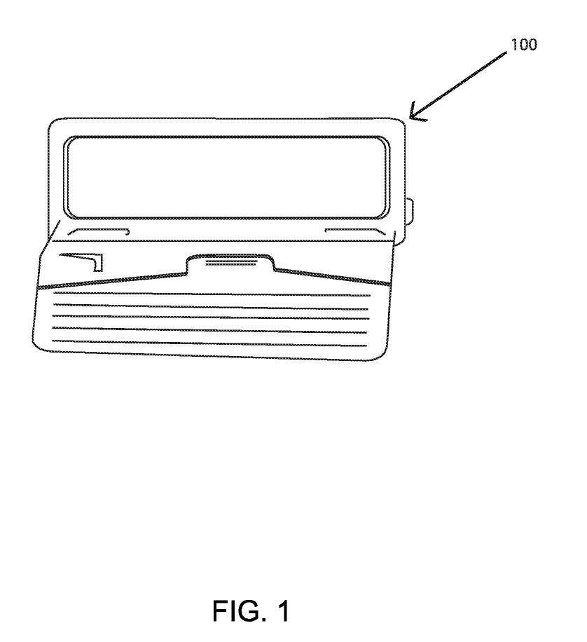

The system used to execute the method of the present invention allows the present invention to interconnect a large number of users with a vast range of expertise. As can be seen in FIG. 1, the system includes at least one remote server, which is used to manage interactions between the employer network and the jobseeker network and is used to execute some internal processes of the present invention. The remote server is able to identify the users that are employers as a plurality of employer accounts, and, thus, the remote server manages each employer account (Step A). An employer account is created on the present invention so that a user can submit at least one job posting on the present invention. The job posting describes a job opportunity that needs to be filled by an employee. Likewise, the remote server is able to identify the users that are looking for job opportunities as a plurality of jobseeker accounts, and, thus, the remote server manages each jobseeker account (Step B). A jobseeker account is created on the present invention so that a user can be alerted to new job openings and be recruited by users within the employer network. Each jobseeker account is associated with a candidate profile, which includes information that is typically found on a professional résumé.

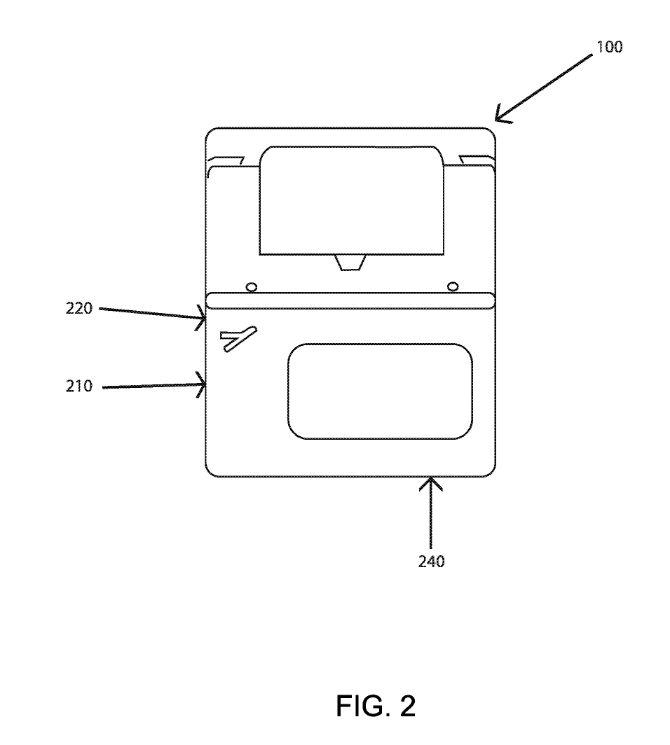

As can be seen in FIG. 2, the overall process followed by the method of the present invention allows users within the employer network to find better-matching, pre-qualified users within the jobseeker network. The overall process begins by retrieving employment qualifications for any candidate profile through a corresponding jobseeker local computer (Step C). The employment qualifications describe a user's career experiences, professional abilities, certifications, or any information that could attract potential employers. The corresponding jobseeker local computer is any kind of computing device that allows the user of each jobseeker account to communicate and access the remote server. The overall process continues by retrieving employment requirements for any job posting through a corresponding employer local computer (Step D). The employment requirements describe the necessary professional requirements of anyone that applies to the job opening. The corresponding employer local computer is any kind of computing device that allows the user of each employer account to communicate and access the remote server. The corresponding jobseeker local computer and the corresponding employer local computer can be, but are not limited to, a smartphone, a tablet personal computer, a laptop, or a desktop and are used create a vast communication network between potential employers and jobseekers through the remote server.

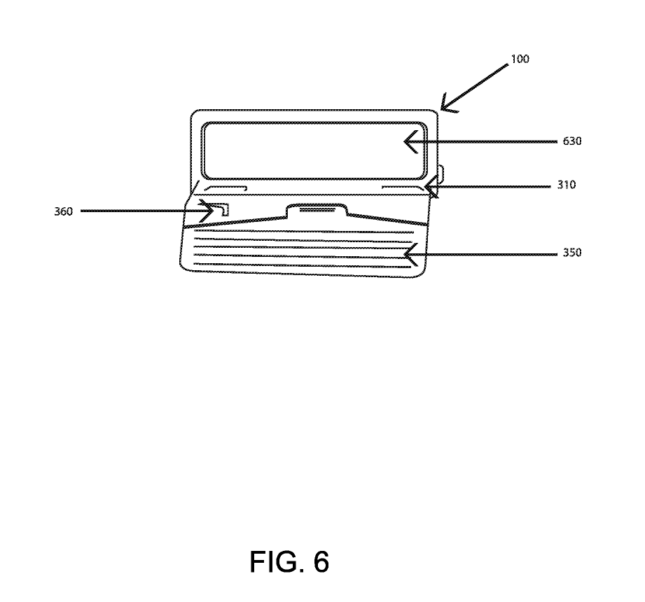

Thereafter, the present invention compares the employment qualifications for each jobseeker account to the employment requirements of an arbitrary job posting with the remote server in order to identify pre-qualified accounts amongst the jobseeker accounts (Step E). The pre-qualified accounts are identified by the remote server because the employment qualifications of the pre-qualified accounts and the employment requirements of the arbitrary job posting share enough common items to be conspicuously recognized by the remote server. The arbitrary job posting is defined as any job posting that is uploaded by any employer account onto the present invention. However, the arbitrary job posting is always associated to a specific employer account from the plurality of employer accounts so that the specific employer account is known by the present invention to have originated the arbitrary job posting. As can be seen in FIG. 6, Step E is automatically executed by the remote server in real-time so that the jobseeker accounts have on-going access to new job postings.

The overall process concludes by notifying or alerting the respective accounts about the results generated in Step E. The present invention sends a notification of the pre-qualified accounts from the remote server to the corresponding employer local computer of the specific employer account (Step F), which allows the user of the specific employer account to view and study the candidate profiles of the pre-qualified accounts. In addition, the present invention sends an alert for the arbitrary job posting from the remote server to the corresponding jobseeker local computer of each pre-qualified account (Step G) in order to make the user aware of the potential job opening. The alert for the arbitrary job posting is sent in real-time via email or text messaging.

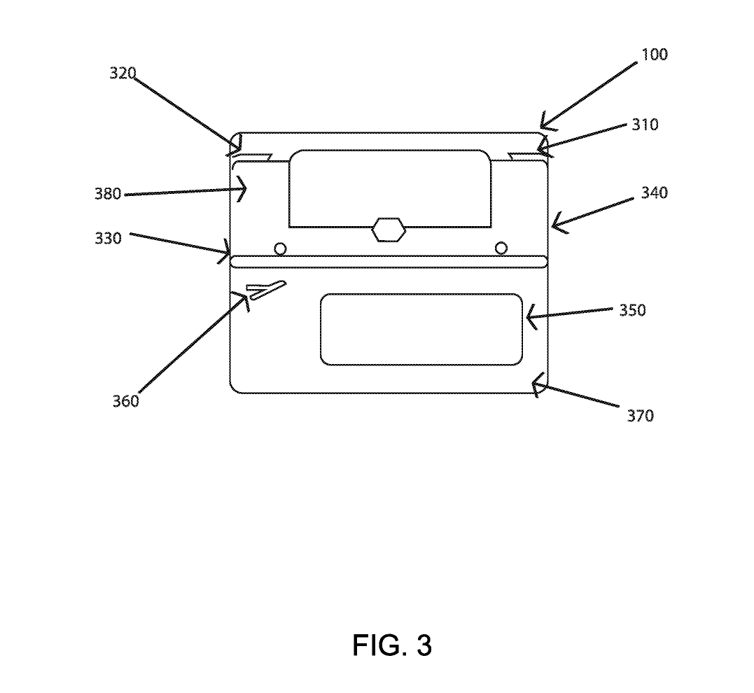

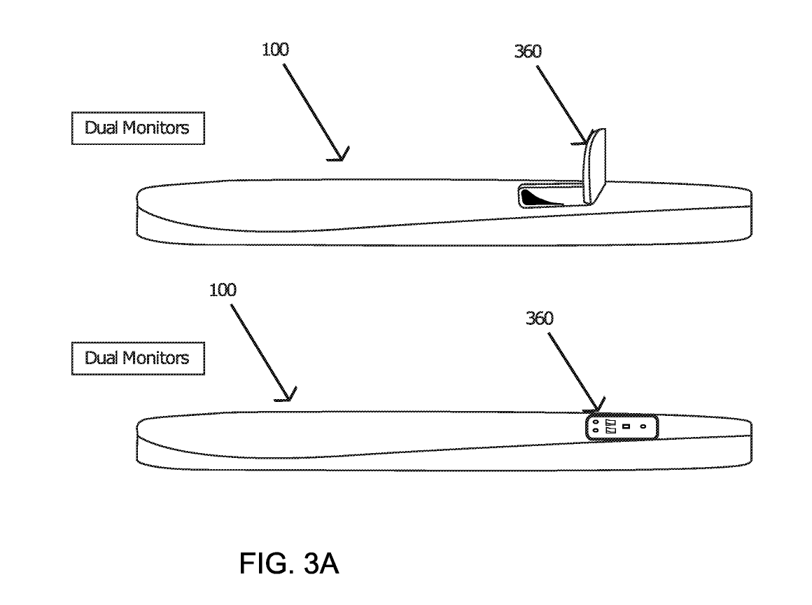

One feature of the present invention that allows the remote server to find more accurate matches between job postings and candidate profiles is job posting templates and job seeking criteria, which is shown in FIG. 3. A job posting template describes the pieces of information that should be included into a job posting. Job seeking criteria describes the kind of job openings that a user is looking to find with the present invention. If a job posting template and job seeking criteria are both associated to an arbitrary job posting, then the present invention can contextually format the job posting template and the job seeking criteria to retrieve similar pieces of information. These similar pieces of information preferably include, but are not limited to, kind of industry, job type, job status, travel distance, salary range, industry experience, college degree, language requirements. Thus, the present invention prompts the specific employer account through the corresponding employer local computer to input the employment requirements of the arbitrary job posting in accordance to the job posting template. Similarly, the present invention prompts each jobseeker account through the corresponding jobseeker local computer to input the employment qualifications for their candidate profile in accordance to the job seeking criteria. The end result is that the remote server is able to increase the similar pieces of information between the employment requirements of the arbitrary job posting and the employment qualifications of each pre-qualified account during Step E. This again allows the present invention to find more accurate matches between job postings and candidate profiles.

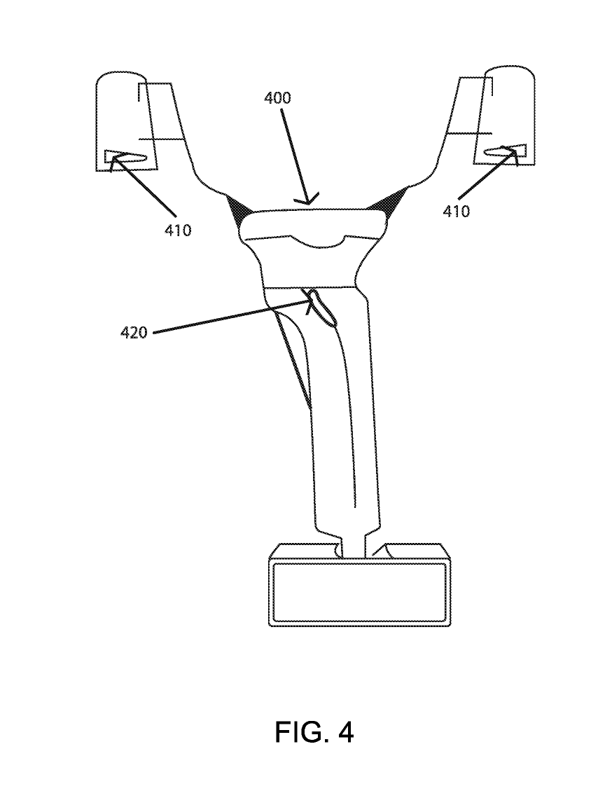

As can be seen FIG. 4, another feature of the present invention that allows the remote server to find more accurate matches between job postings and candidate profiles is self-evaluation surveys. The present invention provides a plurality of job types, which allows the present invention to categorize different kinds of job opportunities. Each of the job types is associated with a set of survey questions, which are used to gather more information about the jobseeker. The process for successfully utilizing the self-evaluation surveys begins by prompting each jobseeker account through the corresponding jobseeker local computer to select a desired job type from the plurality of job types. The desired job type describes the kind of job opportunity that a job seeking user wants to find by using the present invention. This process continues by prompting each jobseeker account through the corresponding jobseeker local computer to complete the survey questions of the desired job type. The self-evaluated ranks to the survey questions of the desired job type are received through the corresponding jobseeker local computer. The self-evaluated ranks are preferably gathered as numerical values that are chosen from a range of 0 to 100 by the job seeking user. The process concludes by enabling the remote server to compile an overall self-evaluation score by averaging the self-evaluation ranks. The overall self-evaluation score allows a potential employer to complete a quick comparison of all of the job seeking users.

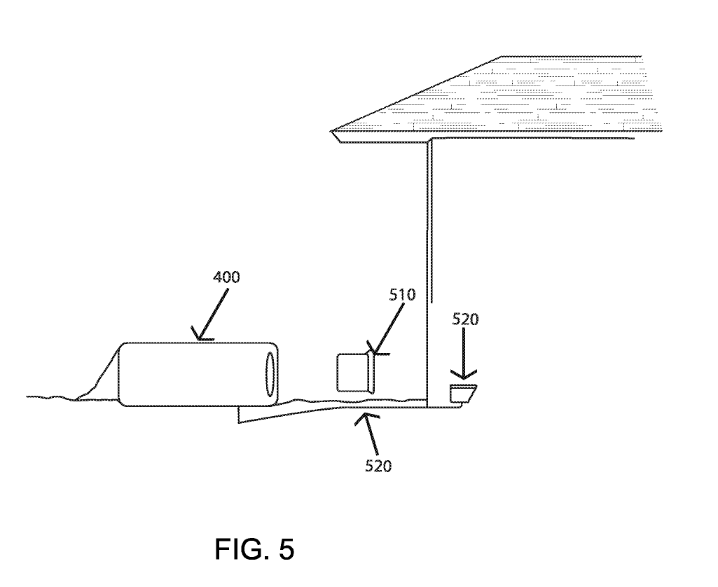

Moreover, the self-evaluation surveys can be used to find even better matches between job posting and candidate profiles by receiving input from potential employers, which is a process depicted in FIG. 5. If the desired job type is associated with an arbitrary job posting, then present invention prompts the specific employer account through the corresponding employer local computer to select essential duties from the survey questions of the desired job type. Each essential duty is associated with a corresponding survey question and is thought by the potential employer to be an important indication of how well a job seeking user would be able to perform at the desired job type. The remote server is enabled to compile an overall essential duties evaluation score by averaging the self-evaluated ranks associated with the essential duties. The overall essential duties evaluation score should be a more accurate gauge than the overall self-evaluation score for how the potential employer wants the job seeking user to perform at the desired job type.

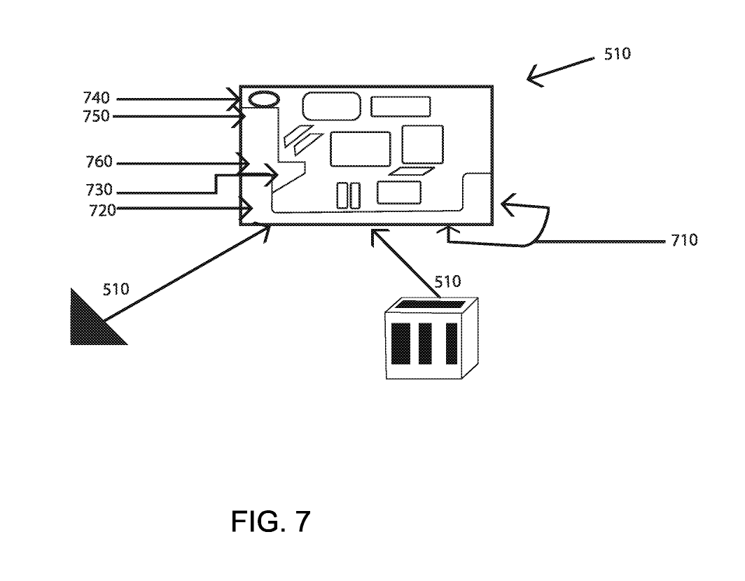

As can be seen in FIG. 7, another feature of the present invention that allows the remote server to find more accurate matches between job postings and candidate profiles is an interview process. The present invention is provided with a set of interview criteria that allow a potential employer to judge a job seeking user during the interview process. The interview criteria preferably include, but are not limited to, appearance, bearing, expression, job knowledge, motivation, and personality. The interview process begins by prompting the specific employer account through the corresponding employer local computer to select and to interview a desired jobseeker account from the pre-qualified accounts. The desired job seeker account is selected as which one of the pre-qualified accounts would be able to perform the best at the job opportunity according to the potential employer. In addition, the potential employer is associated to the specific employer account. As the potential employer is conducting the real-life interview for the job seeker user associated to the desired jobseeker account, the present invention prompts the specific employer account through the corresponding employer local computer to input a score for each interview criteria for the specific employer account. Similar to the self-evaluated ranks, the score for each interview criteria is preferably gathered as a numerical value that are chosen from a range of 0 to 100 by the potential employer. The interview process for the present invention continues by enabling the remote server to compile an overall interview score by averaging the score of each interview criteria, which allows the potential employer to view the entire interview process as a single numerical value. In addition, the present invention may also receive and record a set of interview comments from the specific employer account through the corresponding employer local computer. The interview comments made by the potential employer can be of any contextual nature.

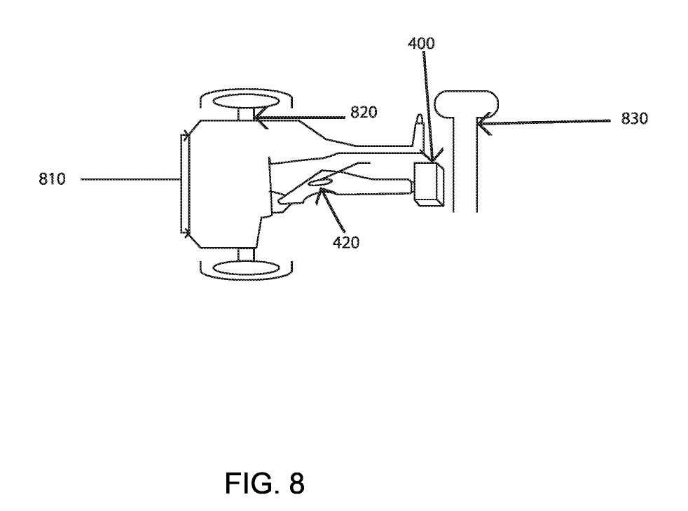

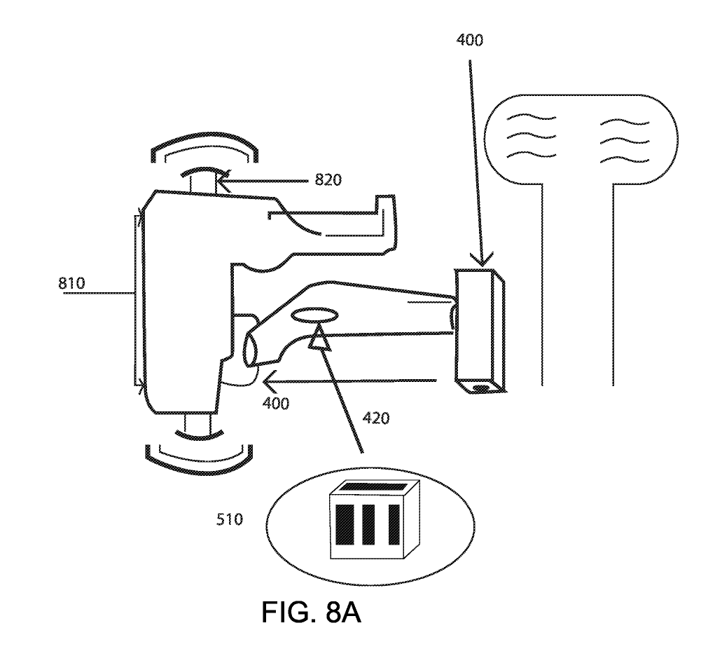

Another feature of the present invention that allows the remote server to find more accurate matches between job postings and candidate profiles is a graphical summary interface, which has a process detailed in FIG. 8. In order to use the graphical summary interface, the present invention needs to prompt the specific employer account through the corresponding employer local computer to view a desired jobseeker account from the pre-qualified accounts. Again, the desired jobseeker account is selected as which one of the pre-qualified accounts would be able to perform the best at the job opportunity according to the potential employer. The present invention then displays the employment qualifications, the overall self-evaluation score, and the essential duties evaluation score on the graphical summary interface through the corresponding employer local computer. The graphical summary interface allows the potential employer to view all of necessary information for the job seeking user associated to the desired jobseeker account into one single display.

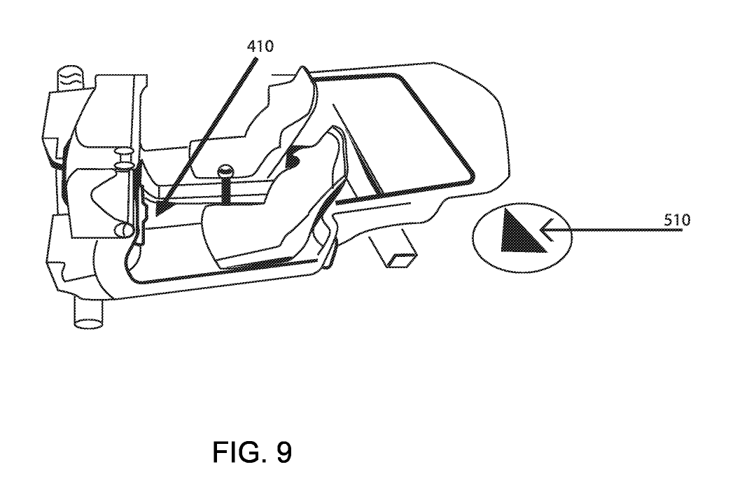

As can be seen in FIG. 9, another feature of the present invention is a process to automatically update the candidate profile for a job seeking user after the job seeking user is hired for a job. This process begins by prompting the specific employer account through the corresponding employer local computer to change a desired jobseeker account from the pre-qualified accounts to a hired status for the arbitrary job posting. The hired status for the arbitrary job posting means that the arbitrary job posting is filled by the job seeking user associated to the desired jobseeker account. Once the desired jobseeker account is changed to the hired status, the remote server then contextually updates the candidate profile of the desired jobseeker account with the employment requirements of the arbitrary job posting so that the candidate profile shows that the job seeking user was hired by the potential employer.

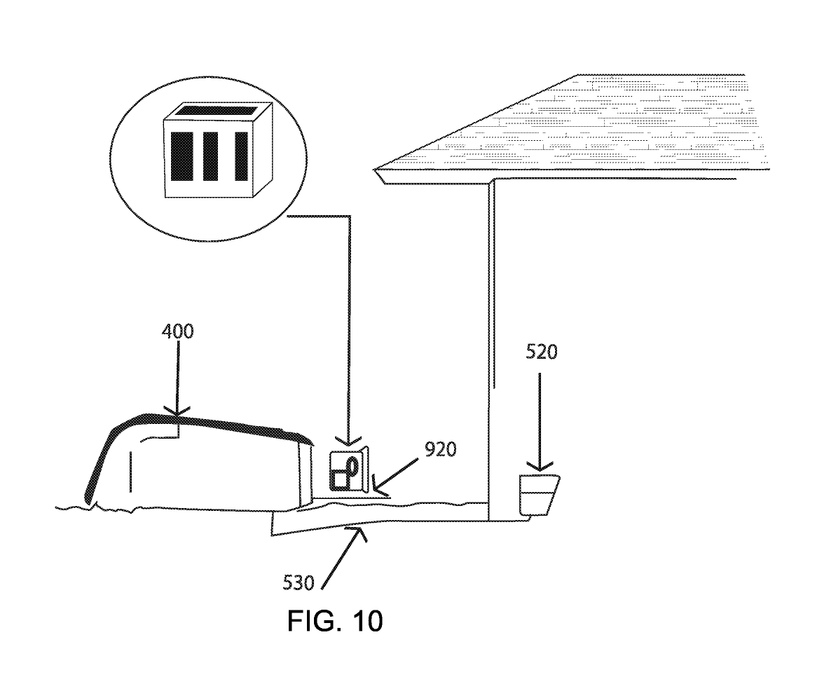

As can be seen in FIG. 10, another feature of the present invention is to charge a monthly fee to the employers for using the present invention, which would prevent unnecessary commission increases. Thus, the remote server is enabled to proportionately charge a monthly fee to each employer account based on a total number of job postings generated by each employer account. For example, if a first potential employer had 50 job postings per month on the present invention and a second potential employer had 100 job postings per month on the present invention, then the monthly fee of the second potential employer would be higher than the monthly fee of the first potential employer.

Although the invention has been explained in relation to its preferred embodiment, it is to be understood that many other possible modifications and variations can be made without departing from the spirit and scope of the invention as hereinafter claimed.

What is claimed is:

1. A computing system unit, comprising:
a motherboard, said motherboard comprising at least one motherboard, in which said motherboard comprising a battery cell, wherein said battery cell is imbedded in said motherboard configured to enable quick charging of said system unit; and the perpetual changing of computer program sequences.
a cell battery charging station, wherein said cell battery charging station is configured to charge said battery cell, in which said battery cell comprising a rechargeable battery cell;
a modulator energy chamber, in which said modulator energy chamber is coupled with said battery cell;
a satellite reception receiver, in which said satellite reception receiver is configured to intersect wireless signals, wherein said intersected signals are routed to said battery cell and cell battery charging station to substantially charge said battery cell;
a first monitor, wherein said first monitor comprising a non-detachable monitoring means, and wherein said first monitor further comprising a touch screen monitor, in which said non-detachable folding common monitor is disposed proximate a top portion and approximately above a centerfold portion of said unit;
a second monitor, wherein said second monitor comprising a non-detachable monitoring means, and wherein said second monitor further comprising a touch screen, in which said second monitor is disposed proximate a base of said unit and approximately below said centerfold portion of said unit;
a third monitor, wherein said third monitor comprising a touch screen monitoring means, and wherein said third monitor further comprising a detachable mobile viewing monitoring means, in which said third monitor is disposed at a base of said system unit and approximately below said centerfold portion, in which said detachable mobile viewing monitor is configured to be detached from said base and further configured to be affixed to a back portion of said unit;
a head phone jack, in which said head phone jack comprising at least two wireless head phone jacks disposed at an upper left and right portion of said unit;
an operating system means, in which said operating system comprising a flash press operating system; and
a housing means, said housing means is configured to house said system unit.

2. The computing system unit of claim 1, wherein said modulator energy chamber is configured to power homes to reduce consumption strain;

3. The computing system unit of claim 1, wherein said operating system further comprising a single graphic interaction computing structure;

4. The computing system unit of claim 1, further comprising a sensor, said sensor comprising at least two or more pressure or motion sensors configured to detect a finger or limb within a predetermined distance, wherein motion commands are streamed or transferred into said system unit without touching said system unit, and wherein a pointer appears when said sensors detect said finger or limb;

5. The computing system unit of claim 1, in which said battery cell is imbedded in said motherboard with a meshing technique.

6. The computing system unit of claim 1, in which said third monitor further comprising computer gaming buttons on the back face of said third monitor.

7. The computing system unit of claim 1, in which said third monitor further comprising a storage unit and a gaming controller.

8. The computing system unit of claim 1, in which said third monitor further comprising a gaming controller configured to recognize finger prints through buttons on said back portion of said system unit.

9. The computing system unit of claim 1, further comprising a mounted keyboard attachment;

10. The computing system unit of claim 1, further comprising a detachable storage unit;

11. The computing system unit of claim 1, further comprising a voltage regulator configured to maintain appropriate levels of voltage in said at least one motherboard;

12. The computing system unit of claim 1, further comprising a cooling unit configured to displace heat from said at least one motherboard.

13. The computing system unit of claim 1, further comprising a grid opening, in which said grid opening comprising at least two or more grid openings configured to be coupled to an energy modulator chamber unit inside a vehicle.

14. The computing system unit of claim 1, further comprising at least one battery port, at least one slot port and at least one directing unit operable for charging said system unit.

15. The computing system unit of claim 1, wherein said motherboard is disposed under a vehicle console rather them under a hood of said vehicle.

16. The computing system unit of claim 1, further comprising a Global Positioning System (G.P.S.) or alternative form of using Battery cell motherboard.

17. The computing system unit of claim 1, in which said third monitor further comprising a safety device, wherein said safety device is configured to pin point a location of said system unit when said third monitor is detached from said system unit and displayed on said third monitor.

18. A computing system unit, comprising:
means for providing power to said system unit;
means for housing said power providing means to enable quick charging of said housing means;
means for charging said power providing means, in which said power providing means comprising a rechargeable power providing means;
means, coupled with said battery cell, for powering homes;
means for intersecting wireless signals, wherein said intersected signals are routed to said power providing means and charging means to substantially charge said power providing means;
means for displaying, wherein said displaying means is a first non-detachable displaying means, in which said first displaying means is disposed proximate a top portion and approximately above a centerfold portion of said system unit;
means for displaying, wherein said displaying means is a second non-detachable displaying means, and wherein said second, in which said second displaying means is disposed proximate a base of said system unit and approximately below said centerfold portion of said system unit;
means for displaying, wherein said displaying means is a third displaying means, and wherein said third displaying means comprising a detachable displaying means for generally viewing television or gaming experiences, in which said third monitor is disposed at said base of said system unit and approximately below said centerfold portion, in which said detachable displaying means is configured to be detached from said base and further configured to be affixed to a back portion of said system unit where it is configured to control said unit or a small television;
means, wirelessly, for listening to audio, in which said listening means comprising at least two wireless listening means disposed at an upper left and right portion of said system unit;
means for interacting with said system unit;
means for detecting a motion of a finger or limb; and
means for housing said system unit.

19. A computing system unit, comprising:
a motherboard, said motherboard comprising at least one motherboard, in which said motherboard comprising a battery cell, wherein said battery cell is imbedded in said motherboard configured to enable quick charging of said system unit;
a cell battery charging station, wherein said cell battery charging station is configured to charge said battery cell, in which said battery cell comprising a rechargeable battery cell;
a modulator energy chamber, in which said modulator energy chamber is coupled with said battery cell, wherein said modulator energy chamber is configured to power at least a home to reduce consumption strain on said home;
a satellite reception receiver, in which said satellite reception receiver is configured to intersect wireless signals, wherein said intersected signals are routed to said battery cell and cell battery charging station to substantially charge said battery cell for non-plug in devices;
a first monitor, wherein said first monitor comprising a non-detachable monitor, and wherein said first monitor further comprising a touch screen monitor, in which said non-detachable folding common monitor is disposed proximate a top portion and approximately above a centerfold portion of said unit;
a second monitor, wherein said second monitor comprising a non-detachable monitor, and wherein said second monitor further comprising a touch screen monitor and key attachment, in which said second monitor is disposed proximate a base of said unit and approximately below said centerfold portion of said unit;
a third monitor, wherein said third monitor comprising a touch screen monitor, and wherein said third monitor further comprising a detachable mobile viewing monitor for generally viewing television or gaming experiences, in which said third monitor is disposed at a base of said unit and approximately below said centerfold portion, in which said detachable mobile viewing monitor is configured to be detached from said base and further configured to be affixed to a back portion of said unit where it is configured to control said unit or a small television;
a sensor, said sensor comprising at least two or more pressure or motion sensors configured to detect a finger or limb within a predetermined distance, wherein motion commands are streamed or transferred into said system unit without touching said system unit, and wherein a pointer appears when said sensors detect said finger or limb;
a head phone jack, in which said head phone jack comprising at least two wireless head phone jacks disposed at an upper left and right portion of said unit;
an operating system, in which said operating system comprising a flash press operating system; and
a housing means for housing said system unit.

20. The computing system unit of claim 1, in which said third monitor further comprising a safety device, wherein said safety device is configured to pin point a location of said system unit when said third monitor is detached from said system unit, and wherein said location is displayed on said third monitor.
